(19) United States
(12) Patent Application Publication
(10) Pub. No.: US 2019/0289787 A1
(43) Pub. Date: Sep. 26, 2019

(54) FORAGE HARVESTER

(71) Applicant: CLAAS Selbstfahrende Erntemaschinen GmbH, Harsewinkel (DE)

(72) Inventors: Christoph Heitmann, Warendorf (DE); Ingo Boenig, Guetersloh (DE); Bjoern Stremlau, Recke (DE); Frédéric Fischer, Arnsberg (DE); Andre Dammann, Harsewinkel (DE); Stefan Schiewer, Warendorf (DE); Felix Herter, Harsewinkel (DE); Jan Furmaniak, Telgte (DE); Bastian Kriebel, Muenster (DE)

(73) Assignee: CLAAS Selbstfahrende Erntemaschinen GmbH, Harsewinkel (DE)

(21) Appl. No.: 16/352,991

(22) Filed: Mar. 14, 2019

(30) Foreign Application Priority Data
Mar. 23, 2018 (DE) 10 2018 106 915.4

(51) Int. Cl. A01D 43/08; A01F 29/14; A01F 29/12

(52) U.S. Cl. CPC A01D 43/086; A01D 43/085; A01F 29/12; A01F 29/14

(57) ABSTRACT

A forage harvester has multiple working elements for carrying out a crop handling process, a drive system which is divided into a main drive train that includes mechanically driven working elements, and an auxiliary drive train that includes hydraulically driven working elements, a driver assistance system which comprises a memory for storing data and a computing device for processing data stored in the memory, as well as a graphical user interface. The working elements consist of at least one adjustable crop handler, at least one actuator system for adjusting and/or actuating the crop handler, and a control unit for controlling the actuator system. The working element is designed as an automatic adjuster whose mode of operation can be optimized by the driver assistance system. The driver assistance system feeds a throughput-proportional load signal, which can be determined by at least one sensor system, to the particular automatic adjuster.

### CROSS-REFERENCE TO RELATED APPLICATIONS

This application claims priority under 35 USC 119 of German No. 102018106915.4, filed on Mar. 23, 2018, the disclosure of which is herein incorporated by reference.

### BACKGROUND OF THE INVENTION

The present invention relates to a forage harvester comprising multiple working elements for carrying out a crop handling process, a drive system which is divided into a main drive train, which includes mechanically driven working elements, and an auxiliary drive train which includes at least partially hydraulically driven working elements. There is a driver assistance system which comprises a memory for storing data and a computing device for processing data stored in the memory, as well as a graphical user interface. The working elements comprise at least one adjustable crop handler, at least one actuator system for adjusting and/or actuating the at least one crop handler, as well as a control unit for controlling the actuator system.

A forage harvester of the type mentioned above comprises multiple working elements for carrying out a crop handling process, a drive system which is divided into a main drive train, which includes mechanically driven working elements, and an auxiliary drive train which includes at least partially hydraulically driven working elements, a driver assistance system which includes a memory for storing data and a computing device for processing data stored in the memory, as well as a graphical user interface, wherein the working elements include at least one adjustable crop handler, at least one actuator system for adjusting and/or actuating the at least one crop handler, as well as a control unit for controlling the actuator system.

DE 102 41 788 A1 describes a forage harvester comprising a chopper which includes chopper knives distributed around the circumference of a rotationally driven chopper drum. The length of the chopped material, which can be adapted by a control unit depending on the moisture of the crop, is also determined by the rotation speed of the chopper drum. The moisture of the crop is determined with the aid of sensors.

DE 10 2011 005 317 B4 relates to a forage harvester comprising a chopper, wherein the state of wear, in particular, the dullness of the cutting edge of chopper knives, is determined with the aid of a device. In addition, an adjustment of the spacing of the cutting edge and the shear bar of the chopper takes place with the aid of the device. In order to determine the sharpness of the cutting edge, the chopper knife passes through a field of an inductive sensor, the sensor values of which are transmitted to an evaluation unit. Predefined limiting values for the sharpness are stored in the evaluation unit. When the predefined limiting values are fallen below, a sharpening of the cutting edges of the chopper knives is automatically triggered or an operator is informed of the need for sharpening. For this purpose, the evaluation unit is connected to a computer of the forage harvester.

EP 1 380 204 B1 describes a forage harvester comprising an accelerating device which is utilized for accelerating a crop stream consisting of a chopped crop, which is fed along a conveying shaft of the accelerating device. The accelerating device is enclosed, in sections, by a housing, within which the accelerating device is relatively movable with the aid of an axle displacement mechanism, in order to be able to change a distance between the conveying shaft and the accelerating device. The distance is changed depending on the moisture, density, or speed of the crop. The determination of moisture, density, or speed takes place with the aid of a sensor, the signals of which are transmitted to an evaluation and processing unit. The adjustment takes place with the aid of an actuator system which is controlled by the evaluation and processing unit.

With respect to a forage harvester, it is therefore known from the prior art to monitor, with the aid of sensors, working elements which include at least one adjustable crop handler, at least one actuator system for adjusting and/or actuating the at least one crop handler, as well as a control unit for controlling the actuator system, and to control the actuator system depending on an operating or harvesting process parameter detected with the aid of sensors. These are control circuits which are self-contained and operate autonomously. This means that possible interactions of adjustments made to a working element with the mode of operation and quality of other working elements will not be taken into consideration. This has the disadvantage, in particular, that the performance of the forage harvester cannot be fully utilized.

### SUMMARY OF THE INVENTION

The problem addressed by the present invention is that of refining the forage harvester of the initially mentioned type in such a way that the forage harvester has increased efficiency, in particular, by an optimized total power uptake.

This problem is solved according to the invention by a forage harvester which comprises multiple working elements for carrying out a crop handling process, as well as a drive system which is divided into a main drive train, which includes mechanically driven working elements, and an auxiliary drive train which includes mechanically and/or hydraulically driven working elements. Moreover, the forage harvester comprises a driver assistance system which includes a memory for storing data and a computing device for processing data stored in the memory, as well as a graphical user interface. The working elements include at least one adjustable crop handler, at least one actuator system for adjusting and/or actuating the at least one crop handler, as well as a control unit for controlling the actuator system. According to the invention, in order to increase the efficiency of the forage harvester, it is provided that the particular working element is designed as an automatic adjuster, wherein the mode of operation of each automatic adjuster can be optimized, individually or depending on at least one further automatic adjuster, by way of the driver assistance system, and wherein the driver assistance system is configured for feeding a throughput-proportional load signal of the drive system, which can be determined by at least one sensor system, to the particular automatic adjuster. Due to the detection of load changes in the drive system and due to the transmission of the throughput-proportional load signals, which reflect these load changes, by the driver assistance system to all automatic adjusters, a prompt adaptation of the operating parameters can be carried out by the particular automatic adjusters of a working element, in order to continuously optimize the operation of the working element. In this way, the ratio of total power uptake and throughput can also be optimized. As a part thereof, a total power uptake of the forage harvester and its chronological sequence can be determined. Interactions between the working elements occurring due to throughput fluctuations are taken into consideration by the particular automatic adjuster during the adjustment or adaptation of the operating parameters. Thus, an increase of the amount of crop picked up results, in principle, in an increased total power uptake of the forage harvester, which can be divided differently between the various working elements, however.

In particular, the driver assistance system can comprise selectable, working element-specific strategies stored in the memory for optimizing the mode of operation of the individual working elements. The individual selectability of working element-specific strategies offers the advantage that this specifies what to focus on in the optimization of the mode of operation. Thus, the working element-specific strategies can have “efficiency”, “costs”, “output”, and “work quality”, for example, as the target settings. The list provided above is to be understood to incomplete. These objectives of working element-specific strategies can vary according to the particular working element to be optimized, since identical objectives or strategies cannot be provided for all working elements.

For this purpose, the selectable, working element-specific strategies can each be directed to a target of the adjustment or of the optimization of at least one harvesting process parameter by specifying at least one operating parameter of at least one of the working elements. Qualitatively and quantitatively determinable working results of individual working elements, up to the working result of the forage harvester as a whole, can be considered to be harvesting process parameters, for example, compressibility of crop, rate of work, ensilability of crop, power requirement, and the like, which are influenced by one or multiple operating parameters of at least one of the working elements.

The type and scope of an optimization of the particular power uptake by the working elements is determined by the target sought as part of a selected, working element-specific strategy.

According to one embodiment, in order to determine at least one throughput-proportional load signal, at least one sensor system can be assigned to at least one working element in the main drive train, in order to detect changes in the power uptake of the at least one working element. It is advantageous that the power uptake as well as changes in the power uptake of the at least one working element can be inferred on the basis of the throughput-proportional load signals determined with the aid of the sensor system. Thus, with the aid of the at least one sensor system, a monitoring of the working element can be carried out in order to detect changes of the power uptake due to wear. For this purpose, a comparison of the presently detected, throughput-proportional load signals with stored, older load signals, which were detected under essentially identical operating conditions, can be carried out. A resultant significant increase of the power uptake of the working element, for example, of a chopper of the forage harvester, can be an indication of a diminishing sharpness of the chopper knives. The assignment of one sensor system to each of the working elements driven by the drive belt of the main drive train offers the possibility of accounting for the power uptake of the forage harvester.

In addition, the throughput-proportional load signal can therefore be fed to at least one automatic adjuster of a working element driven by the main drive train. In this way, the power uptake of at least one subprocess of the processing in the forage harvester and of the transport through the forage harvester can be determined and evaluated. The evaluation, in particular, of multiple subprocesses with respect to their power uptake as well as taking into consideration the existing interactions between the working elements provided for carrying out subprocesses offers the possibility to optimize the overall process during operation. Thus, the generated load signals, which represent a change of the power uptake of the working element “chopper” as a consumer of a large amount of power due to a change of the crop throughput, can be forwarded to the automatic adjusters of the working elements “front attachment” and “intake conveyor device” driven by the auxiliary drive train, as well as of the chopper. In response to the provided load signals, the automatic adjusters appropriately optimize the operating parameters of the particular working element in a coordinated way. This takes place with consideration for the selected, working element-specific strategy.

Moreover, at least one sensor system can be assigned to at least one working element in the auxiliary drive train in order to determine at least one throughput-proportional load signal. In conjunction with the at least one sensor system assigned to the main drive train, it becomes possible to account for the total power uptake.

In particular, the at least one sensor system can be configured for transmitting measuring signals acquired by the sensor system to the driver assistance system in order to generate load signals. The driver assistance system can generate the particular load signals by evaluating the measuring signals and can feed the load signals to the particular automatic adjuster. In this case, the transmission of the load signals can be limited by the driver assistance system to the automatic adjusters which directly interact with one another.

Moreover, the automatic adjusters can be configured for utilizing the load signals during the optimization of the power requirement of the particular working element.

The at least one sensor system can be configured for indirectly measuring the load of the drive system. Indirect measurements have the advantage that the measurements can generally be carried out more cost-effectively, since sensor systems which measure directly are often more expensive and require a manipulation at the measuring point in order to be able to directly detect the measuring variable. Depending on how the indirect measurements are carried out, design-related interventions into the drive system can be largely or completely avoided.

Particularly preferably, the at least one sensor system can be configured for determining elongation slip in a drive belt of the main drive train. In this case, a deviation of the transmission ratio resulting from greater elongation on the tight side or the load side of the drive belt upstream from the working element driven by a pulley as compared to the slack side downstream from the working element can be determined. The torque present at the particular pulley is proportional to the elongation slip, and so the torque can be inferred. In order to determine the elongation slip, a speed differential of the drive belt upstream and downstream from the pulley can be determined by way of the sensor system. An essential advantage of this sensor system is the real-time capability of the measurements.

For this purpose, the at least one sensor system can include at least one guide roller positioned downstream from a pulley of the at least one working element in the main drive train, the rotational speed of which is detected with the aid of sensors, and the rotational speed of the pulley of the working element can be indirectly or directly detected with the aid of sensors. A speed differential can be determined from the detection of the rotational speeds of the guide roller and the pulley, which makes it possible to infer the elongation slip in the drive belt. In particular, the guide roller can be positioned in the main drive train in such a way that permanent contact with the drive belt is ensured. In this way, a loss of contact between the guide roller and the drive belt due to occurring vibrations is to be prevented. In particular, the detection of the rotational speed of the pulley takes place indirectly by way of a rotational speed detection of the working element driven by the pulley. A speed sensor can be provided for this purpose. This design of the sensor system has the advantage that structural interventions into the drive train can be minimized. In addition, this design of the at least one sensor system for determining the power uptake is distinguished by a simple, compact, and robust configuration. A speed sensor required for detecting the rotational speed is cost-effective. The assignment of one guide roller to each of the working elements driven by the drive belt can be carried out in this way.

According to one preferred refinement, the at least one sensor system can be configured for determining bending vibrations in a drive belt of the main drive train. The continuously detected belt vibrations can be subjected to a frequency analysis in order to determine the frequency of the belt vibrations of the drive belt upstream and downstream from the pulley of the working element driven by the pulley. The determination of the frequencies of the belt vibrations of the drive belt makes it possible to infer a difference of the belt-side forces upstream and downstream from the pulley, which is required for determining the torque.

The at least one sensor system can comprise two distance sensors, wherein one distance sensor can be assigned to the slack side upstream from the at least one working element and one distance sensor can be assigned to the load side downstream from the at least one working element, with the aid of which a deflection of the drive belt of the main drive train can be determined. The particular distance sensor is preferably designed as a contactlessly operating sensor. The arrangement of the two distance sensors of the at least one sensor system can take place on the outer side as well as on the inner side of the drive belt or on alternate sides, in order to detect the distance changes caused by the belt vibrations of the drive belt. The variant of the sensor system comprising at least two distance sensors is characterized, in particular, by an easy integration into the main drive train.

One advantageous refinement provides that the at least one sensor system can be configured for determining a hydraulic power of at least one hydraulic motor situated in the auxiliary drive train. The auxiliary drive train is utilized for driving working elements of the forage harvester designed as a front attachment and an intake conveyor device. In this case, the drive of the front attachment and the intake conveyor device can take place in a power-branched manner, mechanically by way of the main drive train and, additionally, hydrostatically, or purely hydrostatically. The drive of the hydraulic motor takes place by way of a pressure differential between the pressure line and the suction line. The volumetric flow is made available by a hydraulic pump, the drive shaft of which is drivingly connected to a pulley which is driven by the drive belt of the main drive train. The hydraulic pump is preferably designed as an axial piston pump having an adjustable displacement volume.

For this purpose, a pressure sensor can be positioned upstream from the at least one hydraulic motor and a pressure sensor can be positioned downstream from the at least one hydraulic motor. In this way, the pressure differential can be measured at the inflow and the outflow of the hydraulic motor.

In particular, the hydraulic motor can be designed as a fixed displacement motor. This has the advantage that the displacement volume of the hydraulic motor is constant, and so the power of the hydraulic motor can be determined on the basis of the pressure differential and the rotational speed of the hydraulic pump.

### BRIEF DESCRIPTION OF THE DRAWINGS

The present invention is explained in greater detail in the following with reference to exemplary embodiments represented in the drawings.

In the drawings:

FIG. 1 shows a schematic representation of a side view of a self-propelled forage harvester;

FIG. 2 shows a schematic representation of the structure of an automatic adjuster:

FIG. 3 shows a schematic overview of the structure of a driver assistance system;

FIG. 4 shows a schematic partial view of a main drive train of a drive system comprising a sensor system for indirectly measuring the load;

FIG. 5 shows a schematic view of the main drive train comprising a sensor system according to a second embodiment for indirectly measuring the load; and

FIG. 6 shows a schematic view of an auxiliary drive train of the drive system comprising a sensor system according to a third embodiment for indirectly measuring the load.

### DETAILED DESCRIPTION OF THE EMBODIMENTS

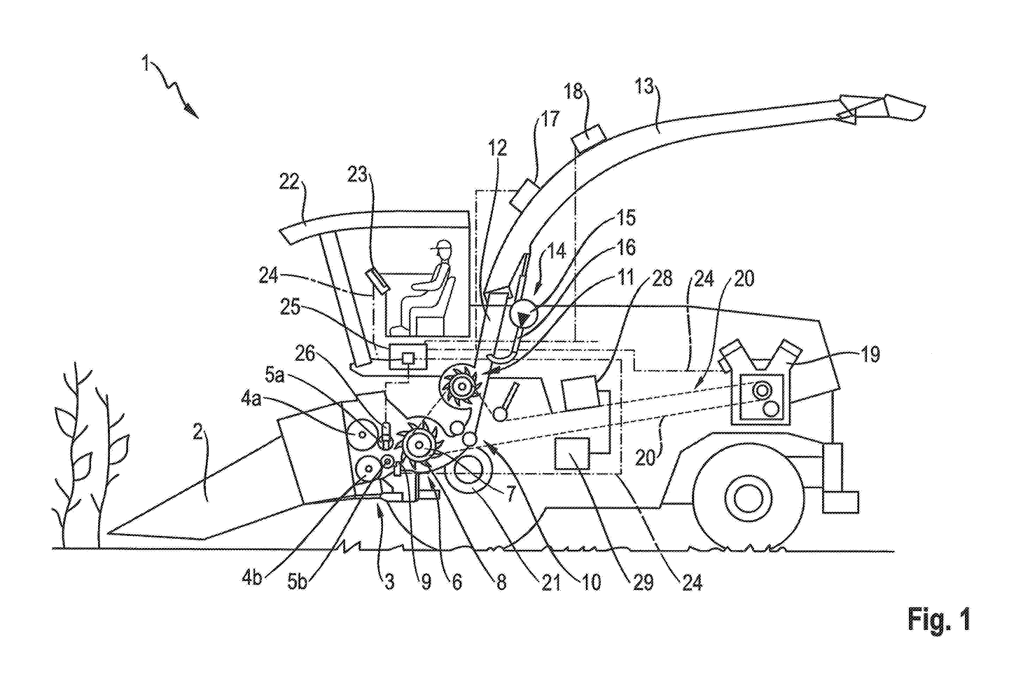

FIG. 1 shows a schematic representation of a side view of a self-propelled forage harvester 1. The forage harvester 1 comprises a front attachment 2 for harvesting, in particular, stalk crop. The front attachment 2 can be designed, inter alia, as a so-called corn header or as a corn picker. For the purpose of harvesting grass, the front attachment 2 can be designed as a mower unit.

The crop picked up by the front attachment 2 is fed to an intake conveyor device 3. The intake conveyor device 3 comprises at least a first roller pair 4a, 4b and a second roller pair 5a, 5b which are situated on a frame or a housing. The at least two roller pairs 4a, 4b and 5a, 5b are utilized for drawing in and compressing the picked-up crop. The roller pairs 4a, 4b and 5a, 5b form an adjustable crop handling means. Thus, for example, the compression force as well as the drive speed of the roller pairs 4a, 4b and 5a, 5b can be changed in order to be adapted to changing crop quantities.

A chopper 6 is positioned downstream from the intake conveyor device 3. The chopper 6 comprises a rotationally driven chopper drum 7 equipped with a plurality of chopper knives 8. The chopper knives 8 rotating with the chopper drum 7 interact with a fixedly situated shear bar 9 of the chopper 6 in order to chop up the crop supplied by the intake conveyor device 3 in the form of a compressed crop mat. The spacing of the shear bar 9 in relation to the enclosing circle of the chopper knives 8 can be adjusted or readjusted. A preferably small spacing contributes to a reduced force requirement during cutting and to a constant cut quality. A sharpening device (not represented) assigned to the chopper 6 is utilized for sharpening the chopper knives 8, as necessary, in order to counter a deteriorating chopping quality resulting from dull chopping knives and to counter an increased energy requirement for driving the chopper 6.

The chopped up crop emerging from the chopper 6 can be fed to an optionally provided after-treatment device 10. The after-treatment device 10, which is also referred to as a conditioning unit or corn cracker, is utilized for the comminution of corn kernels in order to increase the usability or energy efficiency when utilized as feed or in a biogas plant. These types of after-treatment devices 10 consist of a pair of rollers having profiled surfaces, wherein the rollers are driven at different rotational speeds. The speed ratio of the roller pair of the after-treatment device 10 is variable.

The comminution of the grain is determined, in particular, by a gap width between the two rollers of the after-treatment device 10. The smaller the gap width is, the greater the comminution of the grain is. The gap width is adjustable. The after-treatment device 10 can be removed from the crop flow path of the forage harvester 1 as necessary, for example, in order to harvest grass.

From the chopper 6 or the optional after-treatment device 10, the chopped up crop reaches an accelerating device 11 which transfers the crop, through a conveying shaft 12 and an adjoining discharge device 13 designed as a discharge spout, to a transport vehicle (not represented) traveling adjacently to the forage harvester 1. An ensilage agent metering device 14 is situated in the area of the accelerating device 11, which introduces a fluid into the conveying shaft 12 with the aid of a variable-capacity supply pump 15. For this purpose, an injector 16 is provided, which terminates in the conveying shaft 12 and opens in the flow direction of the crop, whereby the fluid is applied in a finely sprayed form onto the crop flowing past. At least one sensor 17 is situated on the discharge device 13, which is configured at least for determining the moisture content of the chopped up crop with respect to the dry mass. The at least one sensor 17 can be designed as an NIR sensor which is also configured for detecting components such as raw ash or the raw protein content of the crop flowing past. One or multiple further sensors 18 for determining the length of cut, the flow speed of the crop, and/or the mass flow of the crop flowing past may be assigned to the discharge device 13.

A drive device 19 designed as an internal combustion engine is provided for driving the forage harvester 1. The drive device 19 is drivingly connected to a drive system 20. The drive system 20 is divided into a main drive train which includes mechanically driven working elements such as the chopper 6, the optional after-treatment device 10, as well as the accelerating device 11, and an auxiliary drive train which includes mechanically and/or hydraulically driven working elements such as the front attachment 2 and the intake conveyor device 3.

The chopper 6 and the accelerating device 11 are driven with the aid of a drive belt 20a. The after-treatment device 10 is drivingly connected to the accelerating device 11 by one further belt. The front attachment 2 and the intake conveyor device 3 can be driven by the auxiliary drive train which can be mechanically coupled to the chopper 6, can be operated mechanically and hydrostatically in a power-split manner, or can be hydrostatically operated independently of the chopper 6. A hydraulic pump 28, which drives a hydraulic motor 29, is provided for the purely hydrostatic drive of the front attachment 2 and the intake conveyor device 3. The hydraulic pump 28 is preferably designed as an axial piston pump having an adjustable displacement volume. The hydraulic motor 29 is designed as a fixed displacement motor. Moreover, a hydrostatic ground drive 21 is provided, with the aid of which the ground speed of the forage harvester 1 can be regulated.

The forage harvester 1 comprises a cab 22, in which an input/output device 23 is provided, which is available to an operator of the forage harvester 1 for the purpose of setting and adjusting operating parameters, for example, and informing the operator about present operating and harvesting conditions. The input/output device 23 is connected to a driver assistance system 25 of the forage harvester 1 by a bus system 24. The bus system 24 also connects the sensors 17, 18 to the discharge device 13 and connects a sensor 26 to the intake conveyor device 3, and connects further sensors and sensor systems 34 and actuators 32 (not represented in FIG. 1) for monitoring as well as adjusting and/or actuating the front attachment 2, the intake conveyor device 3, the chopper 6, the sharpening device, the after-treatment device 10, the accelerating device 11, the ensilage agent metering device 14, the discharge device 13, as well as the ground drive 21, which are referred to in the following as working elements 30, to the driver assistance system 25. The sensors 17, 18 and 26 are described in general in the following under the term “sensor system” 34. Each of these working elements 30 includes at least one adjustable crop handler 31, with the aid of which the crop is manipulated throughout the crop handling process through the forage harvester 1, from the point of having been picked up by the front attachment 2 until it is discharged by the discharge device 13. The at least one actuator system 32 of each working element 30 is utilized for setting, adjusting, and/or actuating the at least one crop handler 31 of a working element 30 according to the particular prevailing harvesting conditions. The sensors or sensor systems 34 monitor operation- and working element-specific parameters of the working elements 30 and of the crop handled by the working elements 30. The term “crop handler” 31 is understood to mean, inter alia, the roller pairs 4a, 4b and 5a, 5b of the intake conveyor device 3, and the chopper knives 8 of the chopper 6.

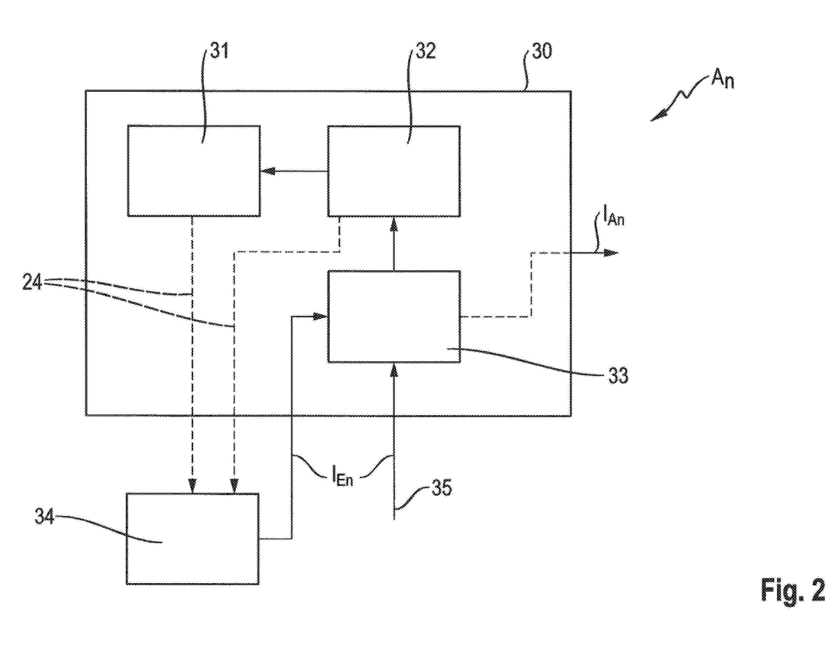

FIG. 2 shows a schematic view of the structure of an automatic adjuster Aₙ. The working element 30 designed as an automatic adjuster Aₙ comprises at least one crop handler 31, an actuator system 32, as well as a control unit 33. Control signals are transmitted from the control unit 33 to the actuator system 32 with the aid of the data bus 24. The at least one crop handler 31 is adjusted with the aid of the actuator system 32. A sensor system 34 monitors the at least one crop handler 31 of the working element 30 and, if necessary, the actuator system 32. The sensor system 34 makes the data it generates available to the control unit 33 for evaluation, by way of the bus system 24. In addition, external information 35 is made available to the control unit 33, which is transmitted to the forage harvester 1, for example, from other working machines and/or a central computer system, and which can influence the crop handling process. The data made available by the sensor system 34, as well as the external information 35, form input signals I_{En} of the automatic adjuster Aₙ. Output signals of the automatic adjuster Aₙ are designated as I_{An}. The automatic adjuster Aₙ autonomously optimizes the mode of operation of the working element 30, i.e., the automatic adjuster Aₙ is configured for continuously autonomously determining and specifying the required adjustments of operating parameters of the working element 30. Operating parameters which have been optimally adapted to the particular present operating and harvesting conditions are made available by the automatic adjuster Aₙ.

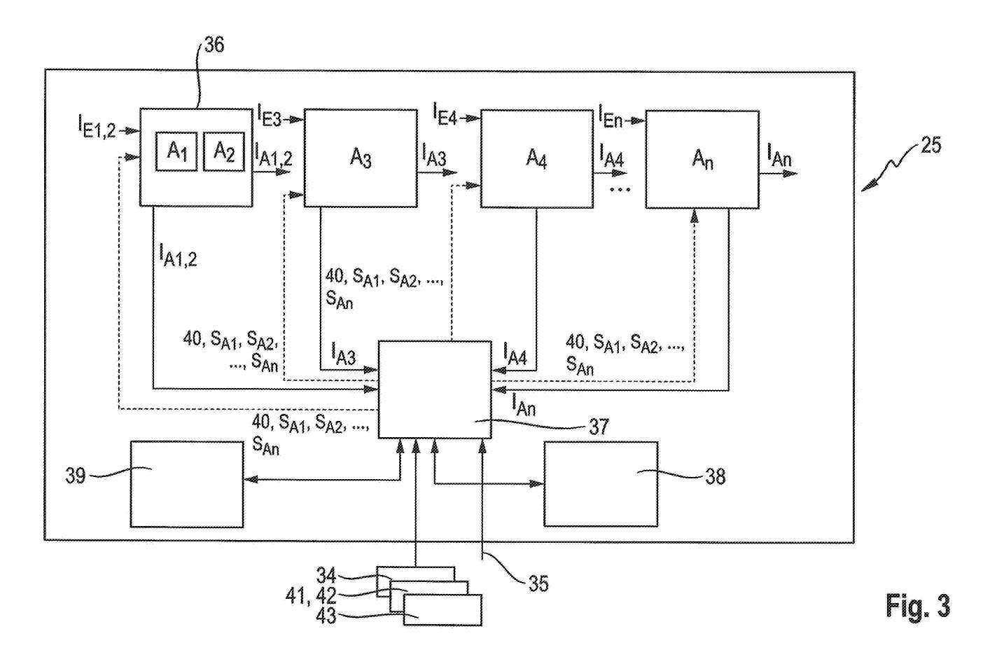

The representation in FIG. 3 shows the schematic overview of the structure of the driver assistance system 25. The driver assistance system 25 comprises multiple automatic adjusters A₁, A₂, A₃, A₄, . . . , Aₙ. In principle, each of the automatic adjusters A₁, A₂, A₃, A₄, . . . , Aₙ operates autonomously. It is conceivable, however, to combine two automatic adjusters A₁, A₂ into one unit, as indicated in FIG. 3 by way of example. It makes sense to combine two automatic adjusters A₁, A₂ when a respective autonomous optimization provides no added value over the direct interaction or dependence between these two automatic adjusters A₁, A₂. Thus, in the case of the forage harvester 1, the automatic adjuster A₁ designed as an automatic front attachment adjuster, which is utilized for optimizing the operating parameters of the front attachment 2, and the automatic adjuster A₂ designed as an automatic intake conveyor device adjuster, which is utilized for optimizing the operating parameters of the intake conveyor device 3, are combined to form one shared automatic adjuster, which is referred to as an automatic feed adjuster 36. Further automatic adjusters are an automatic chopper adjuster A₃, an automatic after-treatment adjuster A₄, and an automatic acceleration adjuster A₅. Further automatic adjusters are conceivable.

The driver assistance system 25 comprises a computing device 37, a memory 38, and a graphical user interface 39. The computing device 37 is configured for processing data stored in the memory 38. In addition, the computing device 37 of the driver assistance system 25 receives and processes data of sensor system 34 as well as external information 35 which has been made available.

The driver assistance system 25 comprises sets of rules stored in the memory 38 and/or in a memory unit of the control units 33 of the automatic adjusters A₁, A₂, A₃, A₄, . . . , Aₙ, which are assigned to the particular automatic adjusters A₁, A₂, A₃, A₄, . . . , Aₙ. The set of rules assigned to the particular automatic adjuster A₁, A₂, A₃, A₄, . . . , Aₙ brings about an optimization of the mode of operation of the particular working element 30 regardless of the mode of operation of the other working elements 30. The sets of rules encompass expert knowledge as well as adaptable characteristic curves or families of characteristics.

The automatic adjusters A₁, A₂, A₃, A₄, . . . , Aₙ are integrated into the driver assistance system 25, which is of a higher order in terms of control hierarchy, wherein the mode of operation of each automatic adjuster A₁, A₂, A₃, A₄, . . . , Aₙ can be optimized by the driver assistance system 25 individually or depending on at least one further automatic adjuster A₁, A₂, A₃, A₄, . . . , Aₙ. Thus, input signals I_{E1}, I_{E2}, I_{E3}, I_{E4}, . . . , I_{En} corresponding to each automatic adjuster A₁, A₂, A₃, A₄, . . . , Aₙ, respectively, are made available by the higher-order driver assistance system 25 and are processed according to the particular set of rules of the automatic adjusters A₁, A₂, A₃, A₄, . . . , Aₙ. In order to optimize the mode of operation of the particular automatic adjuster A₁, A₂, A₃, A₄, . . . , Aₙ, an output signal I_{A1}, I_{A2}, I_{A3}, I_{A4}, . . . , I_{An} is generated, which is utilized for controlling the particular actuator system 32 of the working element 30 controlled by the automatic adjuster A₁, A₂, A₃, A₄, . . . , Aₙ. In addition, the output signals I_{A1}, I_{A2}, I_{A3}, I_{A4}, . . . , I_{An} are transmitted to the computing device 37 of the driver assistance system 25. The driver assistance system 25 makes the output signals I_{A1}, I_{A2}, I_{A3}, I_{A4}, . . . , I_{An} available to the other automatic adjusters A₁, A₂, A₃, A₄, . . . , Aₙ as additional control input signals S_{A1}, S_{A2}, S_{A3}, S_{A4}, . . . , S_{An}. As a result, additional information is available to the driver assistance system 25 and the automatic adjusters A₁, A₂, A₃, A₄, . . . , Aₙ, whereby it is made possible to take interactions with one or multiple other working elements 30, which arise due to changed settings of one working element 30, into account during the optimization of the working elements 30.

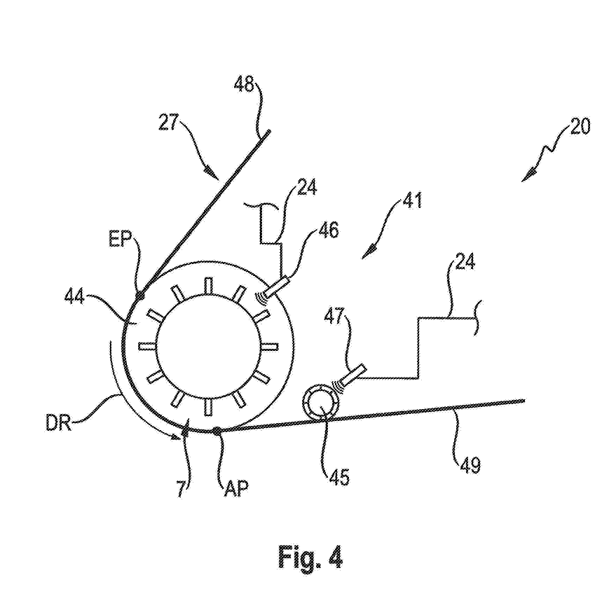

Due to the detection of load changes in the drive system 20 and due to the transmission of the throughput-proportional load signals 40, which reflect these load changes, from the driver assistance system 25 to all automatic adjusters A₁, A₂, A₃, A₄, . . . , Aₙ, a prompt adaptation of the operating parameters can be carried out by the particular automatic adjusters A₁, A₂, A₃, A₄, . . . , Aₙ of a working element 30, in order to continuously optimize the operation of the working element 30. For this purpose, in order to determine a particular load signal 40 in the main drive train and/or in the auxiliary drive train, at least one sensor system 41, 42, 43 is assigned to the main drive train and/or the auxiliary drive train, which is illustrated in FIGS. 4 to 6. The sensor systems 41, 42, 43 are each configured for indirectly measuring the load in the drive system 20.

FIG. 4 shows a partial view of the main drive train of the drive system 20 comprising a sensor system 41 for indirectly measuring the load, which is configured for determining elongation slip in the drive belt 20a upstream and downstream from a pulley 44 of the main drive train, with the aid of which the chopper drum 7 is driven. An arrow DR indicates the direction of rotation of the pulley 44 operating as the output. The sensor system 41 comprises a guide roller 45 which rests against the load side 49 of the drive belt 20a and is driven thereby. The guide roller 45 is positioned as close as possible to the pulley 44 in order to be able to measure the belt speed at the exit point AP of the chopper drum 7 The guide roller 45 is essentially unloaded, in order to avoid the occurrence of slip. The circumferential speed of the guide roller 45 therefore essentially corresponds to the belt speed at the exit point AP. A sensor 47, in particular, a Hall sensor, is provided for measuring the rotational speed of the guide roller 45. One further sensor 46, which is also designed as a Hall sensor, is utilized for detecting the rotational speed of the chopper drum 7. The sensors 46, 47 are connected, for the purpose of signaling, to the driver assistance system 25 by the bus system 24. The driver assistance system 25 evaluates the signals of the rotational speeds received from the sensors 46, 47.

The belt speed at the entry point EP of the slack side 48 of the drive belt 20a can be determined on the basis of the rotational speed of the chopper drum 7. On the basis of the difference of the belt speeds between the entry point EP and the exit point AP, the resultant elongation slip can be determined, which, in turn, correlates with the torque taken up by the chopper 6, and so the power uptake of the chopper 6 can be inferred. By way of the continuous measurement carried out with the aid of the sensor system 41, the throughput-proportional load signals 40 are generated by the driver assistance system 25 and are made available to the automatic adjusters A₁, A₂, A₃, A₄, . . . , Aₙ, and so the automatic adjusters can promptly respond to changes in the throughput of crop.

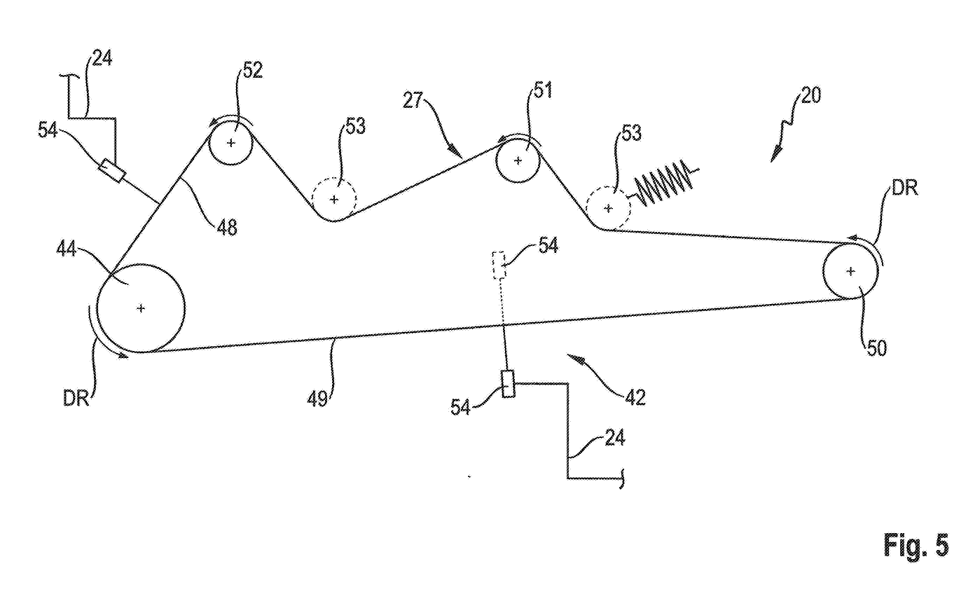

The representation in FIG. 5 shows a schematic view of the main drive train comprising a sensor system 42 according to a second embodiment for indirectly measuring the load. A drive pulley, which is driven by the drive device 19, is designated with the reference numeral 50. Jockey pulleys 53 are utilized for maintaining the belt tension of the drive belt 20a. The hydraulic pump 28 is driven by a pulley 51. One further pulley 52 drives the accelerating device 11 as well as the after-treatment device 10 which is drivingly connected to the accelerating device 11. The sensor system 42 is configured for determining bending vibrations in the drive belt 20a of the main drive train. For this purpose, the sensor system 42 comprises a distance sensor 54 on the slack side 48 upstream from the working element “chopper” 6 and a distance sensor 54 on the load side 49 downstream from the working element “chopper” 6, with the aid of which a deflection of the drive belt 20a of the main drive train can be determined on the basis of belt vibrations. The continuously detected belt vibrations can be subjected to a frequency analysis in order to determine the frequency of the belt vibrations of the drive belt upstream and downstream from the pulley of the working element driven by the pulley. The determination of the frequencies of the belt vibrations of the drive belt 20a makes it possible to infer a difference of the belt-side forces on the slack side 48 upstream from the pulley 44 and on the load side 49 downstream from the pulley 44. The force given off to the chopper 6, which, in turn, is required for determining the torque, can be inferred from the difference of the belt-side forces.

For this purpose, a distance sensor 54 is assigned to the slack side 48 upstream from the chopper 6 and a distance sensor 54 is assigned to the load side 49 downstream from the chopper 6, with the aid of which a deflection of the drive belt 20a of the main drive train can be determined. The distance sensors 54 are preferably designed as contactlessly operating sensors, in order to detect the distance changes of the drive belt 20a caused by the belt vibrations. The signals of the distance sensors 54 are forwarded to the driver assistance system 25 via the bus system 24 for evaluation by the driver assistance system 25. The driver assistance system 25 generates the throughput-proportional load signals 40 and makes them available to the automatic adjusters A₁, A₂, A₃, A₄, . . . , Aₙ.

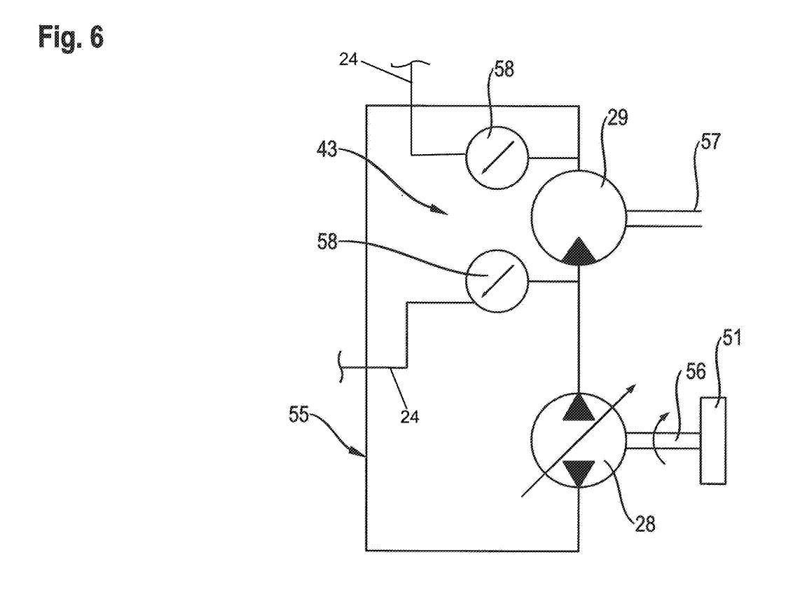

FIG. 6 shows a schematic view of the auxiliary drive train of the drive system 20 comprising a sensor system 43 according to a third embodiment for indirectly measuring the load. The sensor system 43 is configured for determining a hydraulic power of at least one hydraulic motor 29 situated in the auxiliary drive train. In the exemplary embodiment shown, the drive of the front attachment 2 and the intake conveyor device 3 takes place purely hydrostatically by a hydraulic motor 29 in each case. The drive of the hydraulic motor 29 takes place due to a pressure differential between the pressure line and the suction line of a closed hydraulic system 55, and so the displacement volume of the hydraulic motor 29 is identical during every revolution. The hydraulic motor 29 comprises an output shaft 57. A constant volumetric flow is made available by the hydraulic pump 28, the drive shaft 56 of which is drivingly connected to the pulley 51 which is driven by the drive belt 20a of the main drive train. The hydraulic pump 28 is designed as an axial piston pump having an adjustable displacement volume, and so the rotational speed of the hydraulic motor(s) 29 is adjustable. In order to determine the power taken up by the hydraulic motor 29, it is necessary to know the pressure difference at the inflow and the outflow of the hydraulic motor 29. For this purpose, the sensor system 43 comprises two pressure sensors 58 which are utilized at the inflow and the outflow of the hydraulic motor 29 for determining the pressure difference.

The power taken up by the particular hydraulic motor 29 can be determined on the basis of the output rotational speed at the pulley 51 of the hydraulic pump as well as the pressure difference at the inflow and the outflow of the hydraulic motor 29. The evaluation takes place with the aid of the driver assistance system 25, as described above in conjunction with the two other embodiments.

List of reference characters

| | | | |
|---|---|---|---|
| 1 | forage harvester | 29 | hydraulic motor |
| 2 | front attachment | 30 | working element |
| 3 | intake conveyor device | 31 | crop handling means |
| 4a | roller | 32 | actuator system |
| 4b | roller | 33 | control unit |
| 5a | roller | 34 | sensor system |
| 5b | roller | 35 | external information |
| 6 | chopper | 36 | automatic feed adjuster |
| 7 | chopper drum | 37 | computing device |
| 8 | chopper knife | 38 | memory |
| 9 | shear bar | 39 | graphical user interface |
| 10 | After-treatment device | 40 | load signal |
| 11 | accelerating device | 41 | sensor system |
| 12 | conveying shaft | 42 | sensor system |
| 13 | discharge device | 43 | sensor system |
| 14 | ensilage agent metering device | 44 | pulley |
| 15 | supply pump | 45 | guide roller |
| 16 | injector | 46 | sensor |
| 17 | sensor | 47 | sensor |
| 18 | sensor | 48 | slack side |
| 19 | drive device | 49 | load side |
| 20 | drive system | 50 | drive pulley |
| 21 | ground drive | 51 | pulley |
| 22 | cab | 52 | pulley |
| 23 | input/output device | 53 | jockey pulleys |
| 24 | bus system | 54 | distance sensor |
| 25 | driver assistance system | 55 | hydraulic system |
| 26 | sensor | 56 | drive shaft |
| 27 | drive belt | 57 | output shaft |
| 28 | hydraulic pump | 58 | pressure sensor |
| A₁ | automatic adjuster | DR | rotational direction |
| A₂ | automatic adjuster | EP | entry point |
| A₃ | automatic adjuster | AP | exit point |
| A₄ | automatic adjuster | | |
| Aₙ | automatic adjuster | | |
| I_{E1} | input signal | | |
| I_{E2} | input signal | | |
| I_{E3} | input signal | | |
| I_{E4} | input signal | | |
| I_{En} | input signal | | |
| I_{A1} | output signal | | |
| I_{A2} | output signal | | |
| I_{A3} | output signal | | |
| I_{A4} | output signal | | |
| I_{An} | output signal | | |
| S_{A1} | control input signal | | |
| S_{A2} | control input signal | | |
| S_{A3} | control input signal | | |
| S_{A4} | control input signal | | |
| S_{An} | control input signal | | |

What is claimed is:

1. A forage harvester comprising:
multiple working elements for carrying out a crop handling process, the working elements comprising at least one adjustable crop handler, at least one actuator system configured for adjusting and/or actuating the at least one crop handler, as well as a control unit for controlling the actuator system,
a drive system which is divided into a main drive train that includes mechanically driven working elements of the multiple working elements, and an auxiliary drive train that includes at least partially hydraulically driven working elements of the multiple working elements,
a driver assistance system which comprises a memory for storing data and a computing device for processing data stored in the memory, as well as a graphical user interface, and
a sensor system configured for determining a throughput-proportional load signal of the drive system,
wherein each working element is designed as an automatic adjuster (A₁, A₂, A₃, A₄, Aₙ), wherein a mode of operation of each automatic adjuster (A₁, A₂, A₃, A₄, Aₙ) is configured to be optimized, individually or depending on at least one further automatic adjuster (A₁, A₂, A₃, A₄, Aₙ), by the driver assistance system, wherein the driver assistance system is configured for feeding the throughput-proportional load signal of the drive system to a particular automatic adjuster (A₁, A₂, A₃, A₄, Aₙ).

2. The forage harvester as claimed in claim 1, wherein the at least one sensor system is assigned to at least one working element in the main drive train, in order to determine the throughput-proportional load signal, in order to detect changes in a power uptake of the at least one working element.

3. The forage harvester as claimed in claim 1, wherein the at least one sensor system is assigned to at least one working element in the auxiliary drive train, in order to determine the at least one throughput-proportional load signal, in order to detect changes in power uptake of the at least one working element.

4. The forage harvester as claimed in claim 1, wherein the at least one sensor system is configured for transmitting measuring signals acquired by the sensor system to the driver assistance system in order to generate throughput-proportional load signals.

5. The forage harvester as claimed in claim 1, wherein the automatic adjusters (A₁, A₂, A₃, A₄, Aₙ) are configured for utilizing the load signals during optimization of the mode of operation of the particular working element, the mode of operation being optimization a power requirement of the particular working element.

6. The forage harvester as claimed in claim 1, wherein the at least one sensor system is configured for indirectly measuring a load of the drive system.

7. The forage harvester as claimed in claim 1, wherein the at least one sensor system is configured for determining elongation slip in a drive belt upstream and downstream from a pulley of the main drive train.

8. The forage harvester as claimed in claim 7, wherein the sensor system comprises at least one guide roller positioned downstream from a pulley of the at least one working element in the main drive train, wherein sensors of the at least one sensor system are configured to detect rotational speed of the guide roller and of the pulley of the at least one working element in the main drive train.

9. The forage harvester as claimed in claim 1, wherein the at least one sensor system is configured for determining bending vibrations in a drive belt of the main drive train.

10. The forage harvester as claimed in claim 9, wherein the at least one sensor system comprises two distance sensors, wherein one of the distance sensors is assigned to a slack side upstream from the at least one working element and a second one of the distance sensors is assigned to a load side downstream from the working element, wherein the at least one sensor system is configured for determining a deflection of the drive belt of the main drive train.

11. The forage harvester as claimed in claim 1, wherein the at least one sensor system is configured for determining a hydraulic power of at least one hydraulic motor situated in the auxiliary drive train of the drive system.

12. The forage harvester as claimed in claim 11, wherein the at least one sensor system comprises two pressure sensors, a first one of the pressure sensors being positioned upstream from the at least one hydraulic motor and a second one of the pressure sensors being positioned downstream from the at least one hydraulic motor.

13. The forage harvester as claimed in claim 11, wherein the hydraulic motor is designed as a fixed displacement motor.
